(19) United States
(12) Patent Application Publication
(10) Pub. No.: US 2003/0194008 A1
(43) Pub. Date: Oct. 16, 2003

(54) Computationally fast and efficient DV to DVD transcoding

(76) Inventors: Tinku Acharya, Chandler, AZ (US); Hyun M. Kim, Scottsdale, AZ (US); Hyung-Suk Kim, Chandler, AZ (US); Jim Valerio, North Plains, OR (US); Thomas E. Walsh, Banks, OR (US)

Correspondence Address: BLAKELY, SOKOKOFF, TAYLOR & ZAFMAN LLP, Seventh Floor, 12400 Wilshire Boulevard, Los Angeles, CA, 90025-1030, US

(21) Appl. No.: 10/120,799

(22) Filed: Apr. 11, 2002

(51) Int. Cl. H04N 7/12

(52) U.S. Cl. 375/240.12; 375/240.2; 375/240.23; 375/240.01

(57) ABSTRACT

A method is described for quickly and efficiently transcoding digital video (DV) data to digital versatile disk (DVD) data. The method uses the baseline method for DV to DVD transcoding (i.e., full DV decoding, and DVD encoding), but eliminates the DCT and IDCT functions from the baseline method for I (Intraframe) coded frames; and further combines the inverse quantization (IQ) and inverse discrete cosine transformation (IDCT) functions of DV decoding, and the quantization (Q) and discrete cosine transformation (DCT) functions of DVD encoding into a single quantization function for I/P (Intraframe/Predictive) coded frames and P/P (Predictive/Predictive) coded frames.

### BACKGROUND

Video camera recorders have been around for nearly 20 years. People take them everywhere: school plays, sporting events, and reunions. Video camera recording technology has come a long way. For a long time, video camera recorders were analog, where video and audio signals are recorded as analog track on video tape. In time, video camera recorders progressed to the digital format for higher resolution video and better quality audio.

The digital format also enables users to edit the captured DV data which entails downloading the data to a hard drive on a computer system, manipulating frames, sounds, etc., and storing it on a medium, such as on the hard drive, or on a digital versatile disk (DVD). Due to the size of DV data—even several minutes of DV data can quickly squander hard disk—storing DV data onto a DVD has grown in popularity.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 is a block diagram illustrating a high level system in accordance with general embodiments of the invention.

FIG. 2 is a block diagram illustrating an exemplary computer system in accordance with general embodiments of the invention.

FIG. 3 is a block diagram illustrating high level transition from DV data to DVD data.

FIG. 4 is a block diagram illustrating a prior art system for DV to DVD transcoding.

FIG. 5 is a flowchart illustrating a prior art method for DV decoding.

FIG. 6 is a flowchart illustrating a prior art method for DVD encoding.

FIG. 7 is a block diagram illustrating a DV to DVD transcoder for encoding I frames in accordance with general embodiments of the invention.

FIG. 8 is a flowchart illustrating DV to DVD transcoding for encoding I frames in accordance with general embodiments of the invention.

FIG. 9 is a block diagram illustrating a DV to DVD transcoder for encoding I frames based on FIG. 7.

FIG. 10 is a flowchart illustrating DV to DVD transcoding for encoding I/P and P/P frames in accordance with general embodiments of the invention.

### DETAILED DESCRIPTION

In one aspect of embodiments of the invention is a method for a fast and efficient method for DV to DVD transcoding. The process simplifies the baseline method for DV to DVD transcoding. For I-frame (intraframe coded frames) transcoding, the DCT/IDCT functions are removed from the baseline method. For I to P (predictive frame) transcoding, as well as for P to P transcoding, the I-frame method is simplified by combining the IQ function in DV decoding and the Q function in DVD. As a result, the IQ (Inverse Quantization) and IDCT functions of DV decoding; and the DCT (Discrete Cosine Transformation) and Q (Quantization) functions of DVD encoding are combined into a new quantization function using a new quantizer.

Embodiments of the present invention include various operations, which will be described below. The operations associated with embodiments of the present invention may be performed by hardware components or may be embodied in machine-executable instructions, which may be used to cause a general-purpose or special-purpose processor or logic circuits programmed with the instructions to perform the operations. Alternatively, the operations may be performed by a combination of hardware and software.

Embodiments of the present invention may be provided as a computer program product which may include a machine-readable medium having stored thereon instructions which may be used to program a computer (or other electronic devices) to perform a process according to the present invention. The machine-readable medium may include, but is not limited to, floppy diskettes, optical disks, CD-ROMs (Compact Disc-Read Only Memories), and magneto-optical disks, ROMs (Read Only Memories), RAMs (Random Access Memories), EPROMs (Erasable Programmable Read Only Memories), EEPROMs (Electromagnetic Erasable Programmable Read Only Memories), magnetic or optical cards, flash memory, or other type of media/machine-readable medium suitable for storing electronic instructions.

Moreover, embodiments of the present invention may also be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium.

Introduction

The widespread use of DV and DVD in home appliances provides an opportunity for transcoding from DV format to DVD format. DV uses “intraframe” compression, where each frame is an I-frame that is compressed independently of each other. For DVD data, the MPEG-2 standard uses “interframe” compression, in which each frame is an I-frame, P-frame, or a B-frame. Some of the frames are compressed independently (like DV), but most of the frames are compressed using information from the previous and even the following frames. Transcoding is the process of converting a media file or object from one format (i.e., DV) to another (i.e., DVD), where I-frames are converted to any one of an I-frame, P-frame, or B-frame in accordance with a DVD encoding sequence.

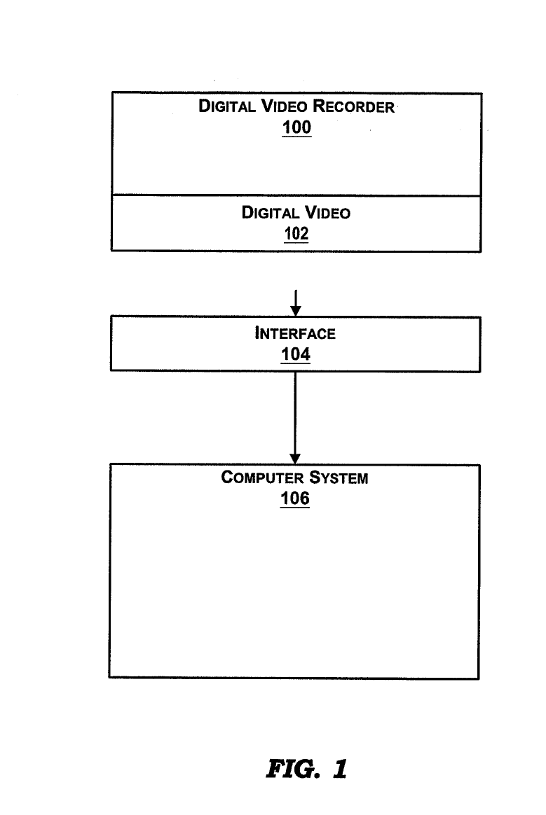

FIG. 1 is a block diagram illustrating a practical application of embodiments of the invention. It comprises a digital video recorder 100 for capturing digital video (DV) 102; an interface 104 for transmitting digital data to a computer system; and a computer system 106.

A digital video recorder 100 stores incoming audio and video on tape in a digital format called digital video (DV) rather than in an analog format such as High 8. A digital video recorder 100 produces full-size, full-motion digital video of 720×480 pixels at 30 frames per second. The DV data 102 can then be transferred to a computer system 106 via a compatible interface 104, such as Apple's™ FireWire™, and Sony's® i.Link®, both of which are based on the IEEE (Institute of Electrical and Electronics Engineers) 1394 industry standard. Other interfaces may be used, such as USB (Universal Serial Bus), and PCI (Peripheral Component Interconnect).

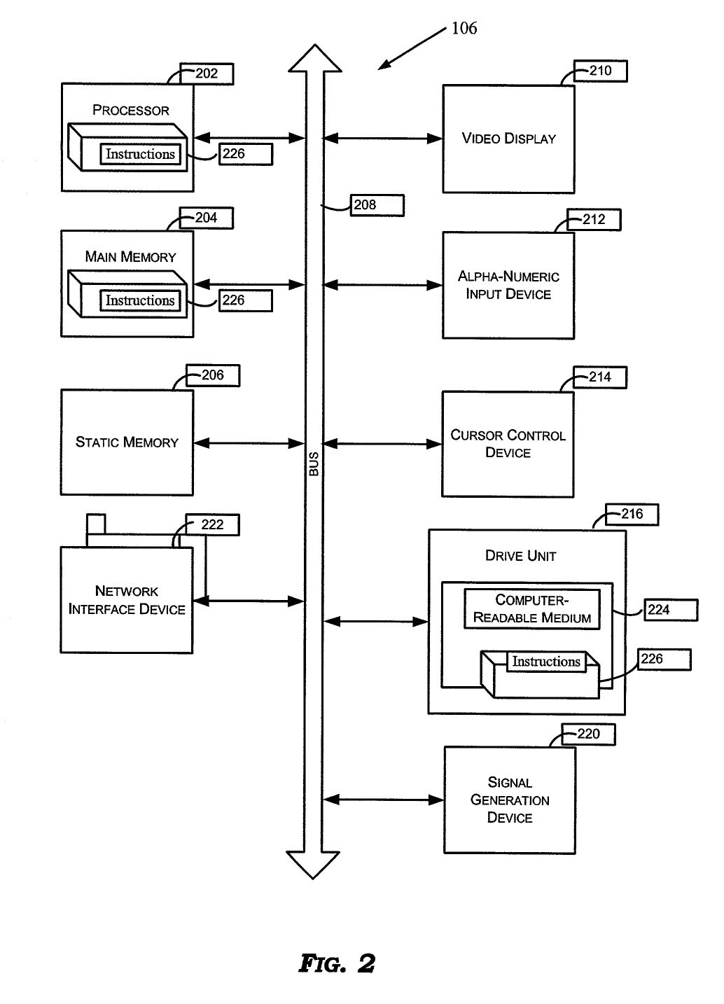

The computer system 106 may be a computer as illustrated in FIG. 2. FIG. 2 is a diagrammatic representation of a machine in the form of computer system 106 within which software, in the form of a series of machine-readable instructions, for performing any one of the methods discussed above may be executed. The computer system 106 includes a processor 202, a main memory 204 and a static memory 206, which communicate via a bus 208. The computer system 106 is further shown to include a video display unit 210 (e.g., a liquid crystal display (LCD) or a cathode ray tube (CRT)).

The computer system 106 also includes an alphanumeric input device 212 (e.g., a keyboard), a cursor control device 214 (e.g., a mouse), a disk drive unit 216 (i.e., DVD R/W (Readable/Writeable) Drive), a signal generation device 220 (e.g., a speaker) and a network interface device 222. The disk drive unit 216 accommodates a machine-readable medium 224 (i.e., DVD) on which software 226 embodying any one of the methods described above is stored, or on which user data (i.e., DVD data) may be stored. The software 226 is shown to also reside, completely or at least partially, within the main memory 204 and/or within the processor 202.

The software 226 may furthermore be transmitted or received by the network interface device 222. For the purposes of the present specification, the term “machine-readable medium” shall be taken to include any medium that is capable of storing or encoding a sequence of instructions for execution by a machine, such as the computer system 106, and that causes the machine to perform the methods in accordance with embodiments of the present invention; or that is capable of storing data that can be read by a machine, such as the computer system 106. The term “machine-readable medium” shall be taken to include, but not be limited to, solid-state memories, optical and magnetic disks, and carrier wave signals.

Captured digital video may be stored on a DVD via a computer system 106. In the computer system, DV data is processed by a processor 202, and written by a disk drive unit 216 (i.e., a DVD R/W drive) to a machine-readable medium 224, (such as a DVD).s

DV to DVD Transcoding

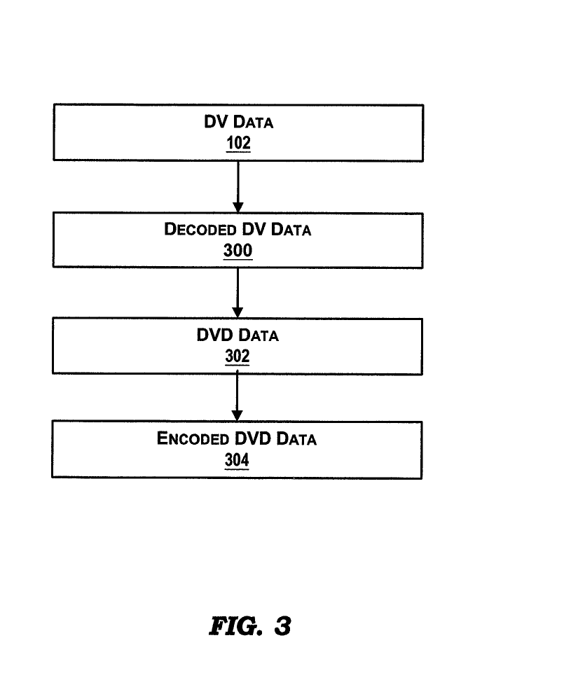

FIG. 3 is a block diagram illustrating a high level transition from DV data to DVD data. It comprises DV data 102, which is a compressed digital video and audio recording standard. The DV data 102 is decoded by a DV decoder to generate decoded DV data 300. The decoded DV data is then converted to DVD data 302 and encoded to generate encoded DVD data 304. Embodiments of the invention describe a DVD encoding method with reference to MPEG-2 (Moving Picture Expert Group-2) standard. However, embodiments of the invention are not to be limited to the MPEG-2 DVD encoding standard.

Baseline DV to DVD Transcoding Method

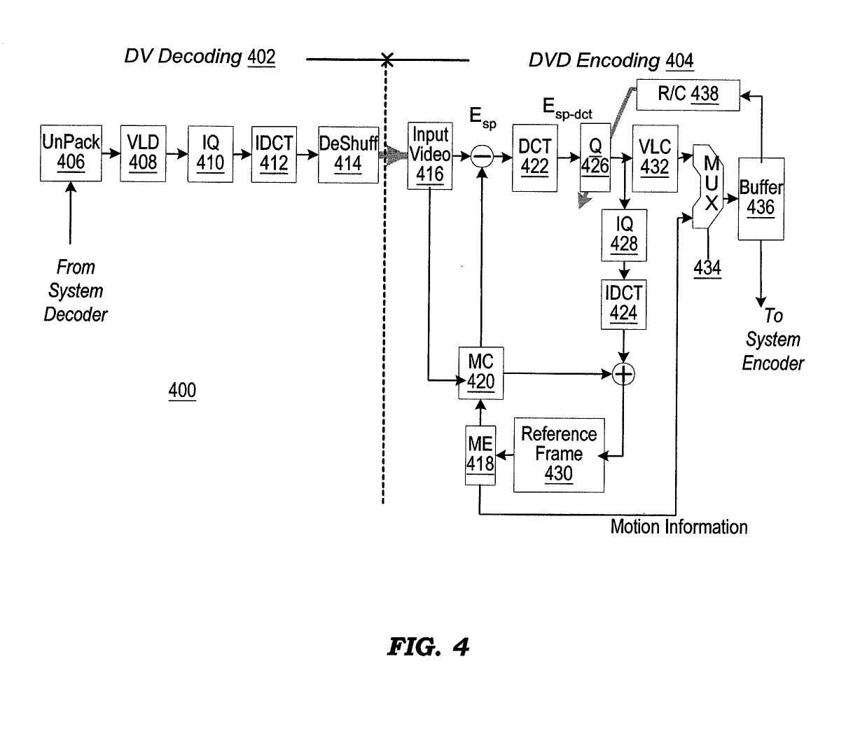

FIG. 4 is a block diagram illustrating a detailed prior art system 400 for DV to DVD transcoding. Prior art system 400 comprises a DV decoder 402 and a DVD encoder 404. DV decoder 402 comprises: unpack function 406; VLD (Variable Length Decoding) function 408; IQ (Inverse Quantizer) function 410; IDCT (Inverse Discrete Cosine Transformation) function 412; and Deshuffling function 414.

A system decoder separates video data from audio data, and an unpack function 406 of DV decoder 402 receives video data input from system decoder and processes the packed video data using a VLD 408. IQ 410 uses VLD data and reconstructs the data by multiplying the data by a quantizer. IDCT 412 takes each 8×8 block of the reconstructed data, and converts the data from a frequency domain to a spatial domain by converting DCT coefficients. Deshuffler 414 then reorders the macroblocks.

DVD encoder 404 comprises: input video function 416 to receive decoded DV data; ME (motion estimation) function 418 to determine how much movement is contained between two successive pictures; MC (motion compensation) function 420 to compensate for changes that occur from picture to picture; a DCT function 422 to concentrate highly correlated neighboring pixels within an image into fewer, decorrelated parameters using an invertible transform, and an IDCT function 424 to perform the reverse of DCT; a Q function 426 to reduce the amount of data by masking unnecessary data, and an IQ function 428 to perform the reverse of Q; a reference frame unit 430 to store a previously transmitted frame for comparison by ME 418 and MC 420; a VLC 432 to encode quantized data; a MUX (multiplexer) 434 to funnel encoded data and motion estimated data to a buffer; a buffer 436 to store encoded data for transmitting to a system encoder; and a rate control mechanism 438 to control the amount of data stored in the buffer.

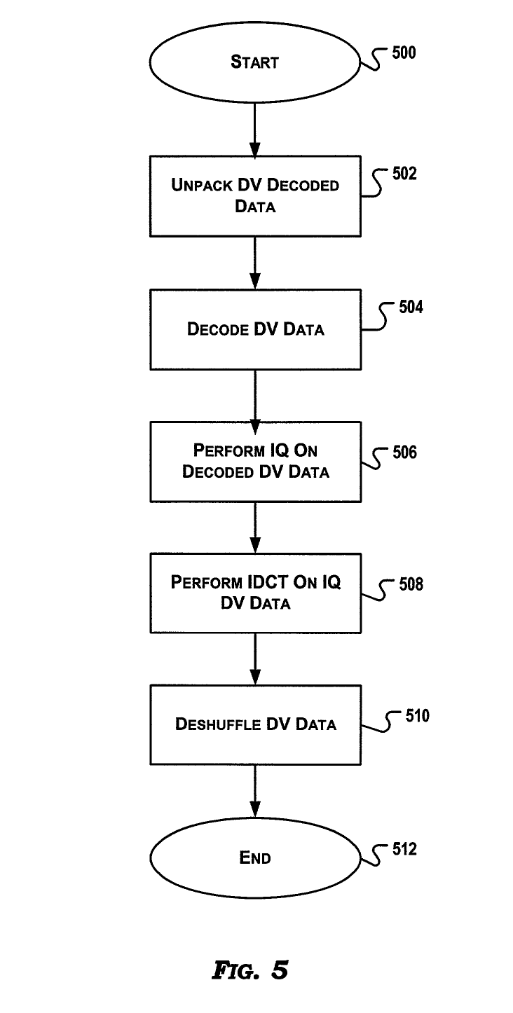

The baseline DV decoding process is illustrated in FIG. 5. The method begins at block 500 and continues to block 502 where decoded DV data is unpacked. The unpacked DV data is then decoded at block 504 using a variable length decoder. At block 506, the decoded data is inversely quantized by multiplying the decoded coefficients by the corresponding values of a quantization matrix and a quantization scale factor. At block 508, inverse discrete cosine transformation is performed on the quantized data, and at block 510, the inversely discrete cosine transformed data is deshuffled by reordering the macroblocks. The method ends at block 512.

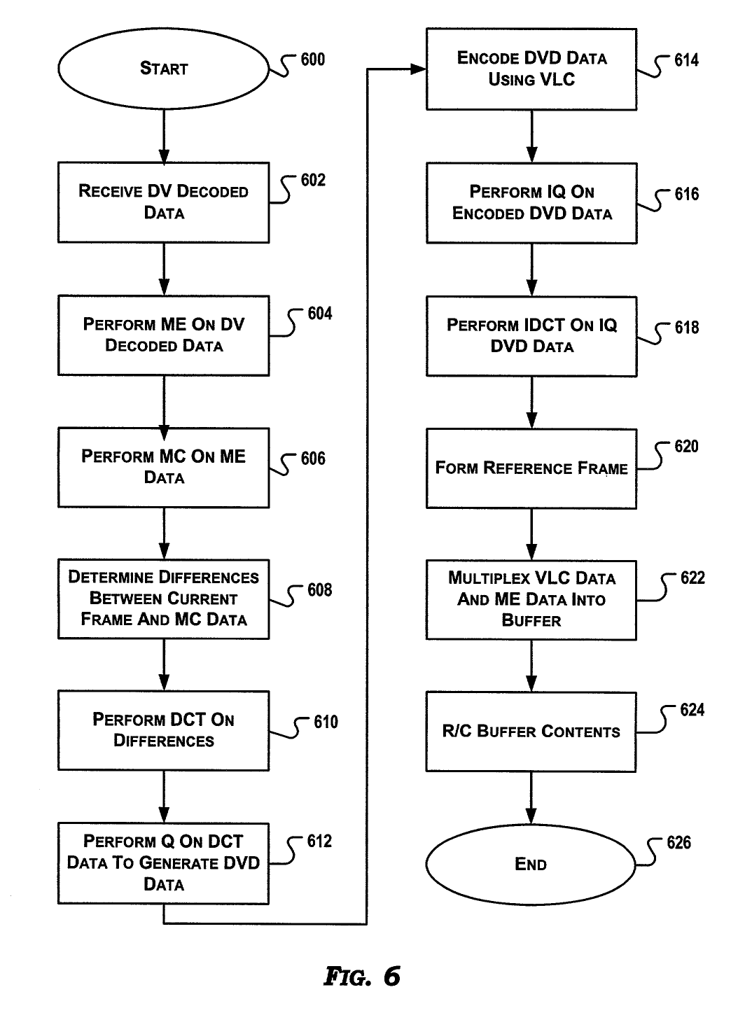

The baseline DVD encoding process is illustrated in FIG. 6. The method begins at block 600 and continues to block 602 where decoded DV data is received. At block 604, motion estimation is performed to determine how much movement there is between the current frame and the reference frame, and at block 606, motion compensation is performed to compensate for changes based on the motion estimation. At block 608, differences between the motion compensated data and the current frame are determined, and at block 610, discrete cosine transformation (DCT) is performed. At block 612, quantization (Q) is performed on the DCT data to generate DVD data. At block 614, the DVD data is encoded using variable length coding.

At block 616, inverse quantization (IQ) is performed on the encoded DVD data, and at block 618, inverse discrete cosine transformation (IDCT) is performed on the IQ DVD data. At block 620, the IQ DVD data is combined with the motion estimated data to form the reference frame for comparison with the next frame. At block 622, the encoded DVD data and motion estimated data are multiplexed into a buffer. To prevent underflow or overflow within the buffer, the buffer contents are controlled by a rate control mechanism at block 624 before the buffers contents are transmitted to a system encoder for combining audio and video data. The method ends at block 626.

Efficient DV to DVD Transcoding

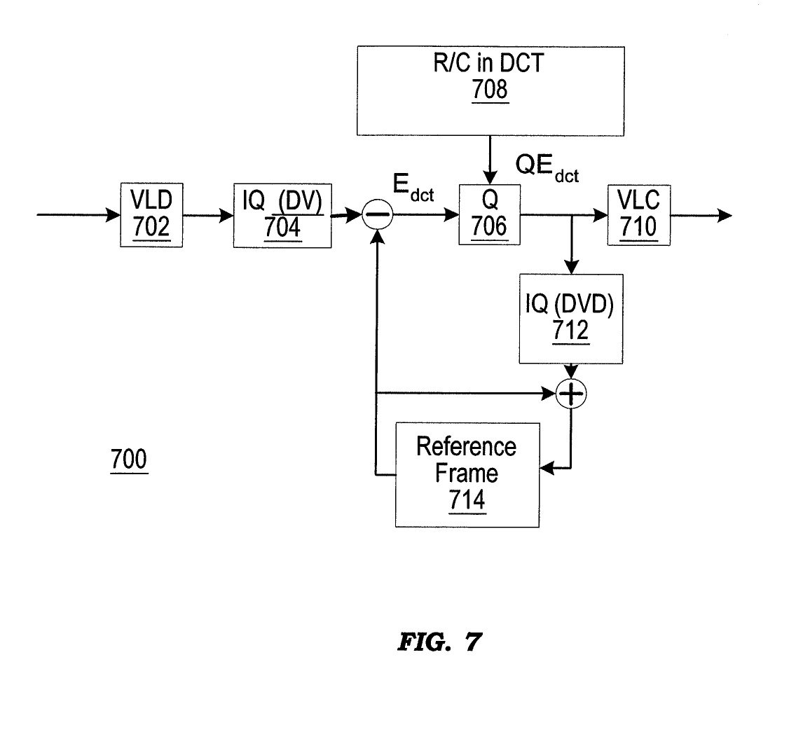

FIG. 7 is a block diagram illustrating a detailed system for DV to DVD transcoding in accordance with general embodiments of the invention. The system 700 comprises a VLD 702 (variable length decoder) for decoding the DV data; an IQ 704 for performing inverse quantization on the decoded DV data; a Q 706 for performing baseline quantization on the decoded DV data; a R/C 708 for controlling the rate at which encoded DVD data is quantized; a VLC 710 to encode variable length encoded DVD data; an IQ 712 to perform inverse quantization on DVD data; and a reference frame unit 714 to store a reference frame for comparing with a current frame.

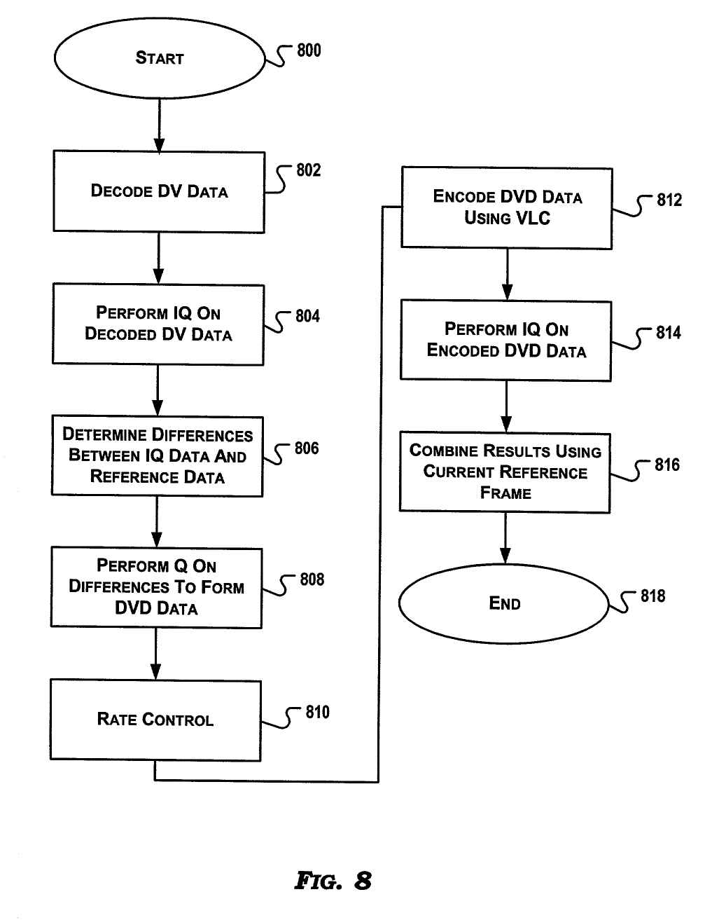

FIG. 8 is a flowchart illustrating a method in accordance with the block diagram of FIG. 7. The method begins at block 800 and continues to block 802 where DV data is decoded, and at block 804, baseline inverse quantization is performed on the decoded data. Baseline inverse quantization involves performing inverse quantization using DCT coefficients that are transmitted with the video data.

At block 806, the differences between the inversely quantized data and a reference frame are determined, and the results are quantized to form DVD data at block 808. At block 810, a rate control mechanism uses DCT coefficients to control the amount of data that is quantized. At block 812, the DVD data is encoded using a variable length coder. At block 814, baseline inverse quantization is performed on the DVD data and those results combined with the current reference frame to produce a new reference frame at block 816 for use on a subsequent pass. The method ends at block 818.

The new and efficient method is equivalent to the baseline method for I frame transcoding, as illustrated by the following:

Let f(m,n) be original 8×8 block in spatial domain where m,n=0,1, . . . , 7. Then the output of DV Quantizer F′(u,v) is

$$\begin{matrix}{F}^{′} ( u , v ) = R [ \frac{DCT ( f ( m , n ) )}{{Q}_{DV}} ] \\ = R [ \frac{F ( u , v )}{{Q}_{DV}} ]\end{matrix}$$

where R denotes round function for quantization and F(u,v) is the DCT coefficients of f(m,n) where u,v=0,1, . . . , 7.

Then the output of DV Inverse Quantizer is:

Q_{DV}·F′(u,v)

*Output of DV IDCT is

IDCT{Q_{DV}·F′(u,v)}=Q_{DV}·IDCT{F′(u,v)} because “Q_{DV}” is a scalar.

*Output of DVD DCT is

DCT{Q_{DV}·IDCT{F′(u,v)}}=Q_{DV}·DCT{IDCT{F′(u,v)}}=Q_{DV}·F′(u,v)

*Output of DVD Quantizer is

$$R [ \frac{{Q}_{DV} \cdot {F}^{′} ( u , v ) }{{Q}_{DVD}} ] = R [ \frac{{F}^{′} ( u , v )}{α} ]$$

where Q_{DVD} is the quantization parameter for DVD.

So we can combine the IQ, IDCT, DCT and Q into single new quantizer using

$$α = \frac{{Q}_{DVD}}{{Q}_{DV}}$$

where Q_{DV} is the quantization parameter for DV.

Further Simplification for I/P and P/P Frames

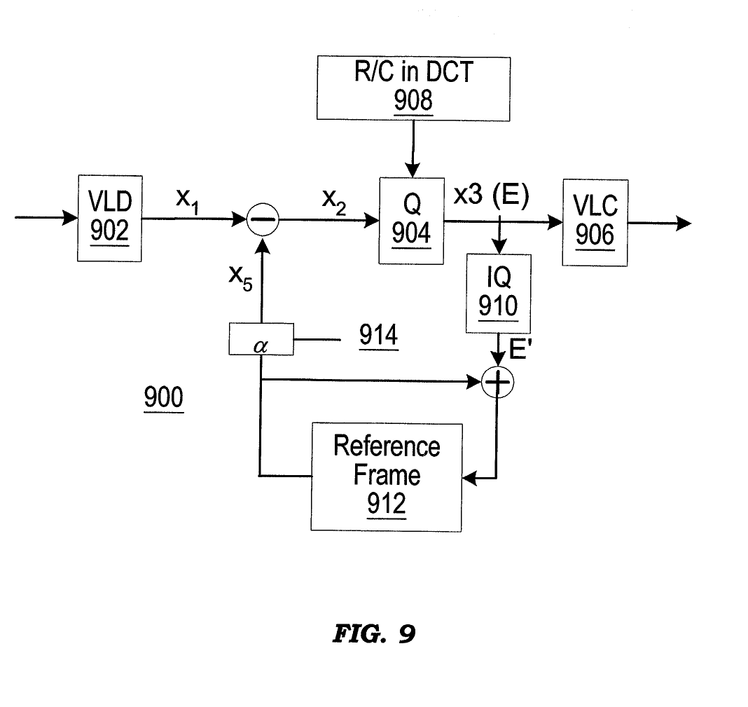

FIG. 9 is a block diagram illustrating a further modification of the baseline method, which is a simplified system of FIG. 7 in accordance with general embodiments of the invention. The system 900 comprises a VLD 902 for decoding the DV data; a Q 904 for performing new quantization on the encoded DVD data; a VLC 906 to encode variable length encoded DVD data; a R/C 908 for controlling the rate at which encoded DVD data is quantized; an IQ 910 to perform inverse quantization on the DVD data; a reference frame unit 912 to store a reference frame for comparing with a current frame; and the new single quantizer 914, α.

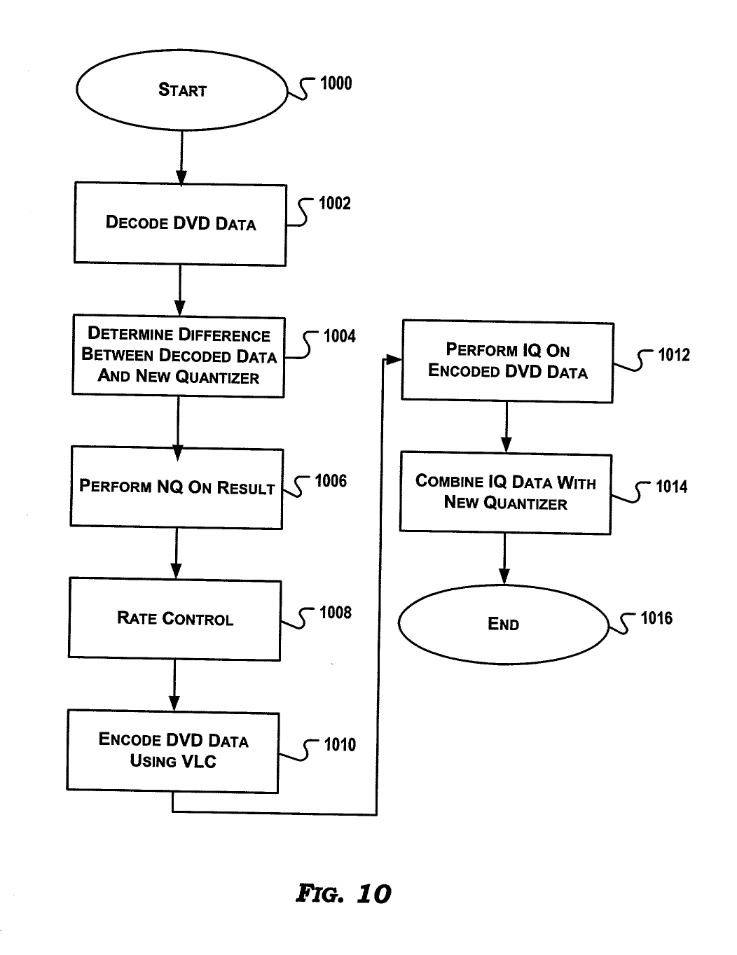

FIG. 10 is a flowchart illustrating a method in accordance with the block diagram of FIG. 9. The method begins at block 1000 and continues to block 1002 where DV data is decoded. At block 1004, the difference between the decoded data and the new single quantizer, α, is determined, and at block 1006, new quantization (NQ) is performed on the result to generate DVD data.

At block 1008, a rate control mechanism controls the amount of data that is quantized. At block 1010, the DVD data is encoded using a variable length coder. At block 1012, inverse quantization is performed on the encoded DVD data, which is combined with the new single quantizer to produce the next reference frame at block 1014. The method ends at block 1016.

The new and efficient method is equivalent to the baseline method for I-P frame transcoding, where the reference frame is an I frame, as illustrated by the following:

Let Bₙ and Bₙ₋₁ be current and previous blocks respectively. Then the prediction error Eₛₚ in baseline method is:

$$\begin{matrix}{E}_{SP} = IDCT \{ {Q}_{{DV}_{1}} \cdot R [ \frac{DCT ( {B}_{n} )}{{Q}_{{DV}_{1}}} ] \} - IDCT \{ {Q}_{DVD} \cdot R [ \frac{DCT \{ IDCT \{ {Q}_{{DV}_{2}} \cdot R [ \frac{DCT ( {B}_{n - 1} )}{{Q}_{{DV}_{2}}} ] \} \}}{{Q}_{DVD}} ] \} \\ = IDCT \{ {Q}_{{DV}_{1}} \cdot R [ \frac{DCT ( {B}_{n} )}{{Q}_{{DV}_{1}}} ] \} - IDCT \{ {Q}_{DVD} \cdot R [ \frac{{Q}_{{DV}_{2}} \cdot R [ \frac{DCT ( {B}_{n - 1} )}{{Q}_{{DV}_{2}}} ]}{{Q}_{DVD}} ] \}\end{matrix}$$

where Q_{DV}_{₁} and Q_{DV2} are quantizers for Bₙ and Bₙ₋₁ respectively. Then the prediction error after DCT is

$$\begin{matrix}{E}_{SP - DCT} = DCT ( {E}_{SP} ) \\ = DCT \{ IDCT \{ {Q}_{{DV}_{1}} \cdot R [ \frac{DCT ( {B}_{n} )}{{Q}_{{DV}_{1}}} ] \} - IDCT \{ {Q}_{DVD} \cdot R [ \frac{{Q}_{{DV}_{2}} \cdot R [ \frac{DCT ( {B}_{n - 1} )}{{Q}_{{DV}_{2}}} ]}{{Q}_{DVD}} ] \} \} \\ = {Q}_{{DV}_{1}} \cdot R [ \frac{DCT ( {B}_{n} )}{{Q}_{{DV}_{1}}} ] - {Q}_{DVD} \cdot R [ \frac{{Q}_{{DV}_{2}} \cdot R [ \frac{DCT ( {B}_{n - 1} )}{{Q}_{{DV}_{2}}} ]}{{Q}_{DVD}} ]\end{matrix}$$

Let E_{DCT} be the prediction error in FIG. 2 then we have

$${E}_{DCT} = {Q}_{{DV}_{1}} \cdot R [ \frac{DCT ( {B}_{n} )}{{Q}_{{DV}_{1}}} ] - {Q}_{DVD} \cdot R [ \frac{{Q}_{{DV}_{2}} \cdot R [ \frac{DCT ( {B}_{n - 1} )}{{Q}_{{DV}_{2}}} ]}{{Q}_{DVD}} ]$$

Hence

E_{SP-DCT}=E_{DCT}

So we can remove the DCT/IDCT in I-P transcoding.

Let QE_{DCT} be the prediction error after quantization in FIG. 2 then we have:

$${QE}_{DCT} = R [ \frac{{Q}_{{DV}_{1}} \cdot R [ \frac{DCT ( {B}_{n} )}{{Q}_{{DV}_{1}}} ] - {Q}_{DVD} \cdot R [ \frac{{Q}_{{DV}_{2}} \cdot R [ \frac{DCT ( {B}_{n - 1} )}{{Q}_{{DV}_{2}}} ]}{{Q}_{DVD}} ]}{{Q}_{DVD}} ]$$

Let x₁ and x₅ denote the current and previously reconstructed block in FIG. 3, then we have:

$$\begin{matrix}{x}_{1} = R [ \frac{DCT ( {B}_{n} )}{{Q}_{{DV}_{1}}} ] \\ {x}_{5} = α \cdot {Q}_{DVD} \cdot R [ \frac{R [ \frac{DCT ( {B}_{n - 1} )}{{Q}_{{DV}_{2}}} ]}{\frac{{Q}_{DVD}}{{Q}_{{DV}_{2}}}} ]\end{matrix}$$

Where α is a compensating constant that makes the dynamic range of the current and previously reconstructed block same for prediction error calculation. Then the prediction error x₂ is

x₂=x₁−x₅

Let x₃ be the quantized output of x₂ then we have:

$$\begin{matrix}{x}_{3} = R [ \frac{{x}_{1} - {x}_{5}}{\frac{{Q}_{DVD}}{{Q}_{{DV}_{1}}}} ] \\ = R [ \frac{R [ \frac{DCT ( {B}_{n} )}{{Q}_{{DV}_{1}}} ] - α \cdot {Q}_{DVD} \cdot R [ \frac{R [ \frac{DCT ( {B}_{n - 1} )}{{Q}_{{DV}_{2}}} ]}{\frac{{Q}_{DVD}}{{Q}_{{DV}_{2}}}} ]}{\frac{{Q}_{DVD}}{{Q}_{{DV}_{1}}}} ]\end{matrix}$$

The denominator

$$\frac{{Q}_{DVD}}{{Q}_{{DV}_{1}}}$$

is introduced for the new combined quantizer.

The proposed method becomes equivalent to the baseline method if x₃=QE_{DCT}. Solving α using this gives:

$$R [ \frac{R [ \frac{DCT ( {B}_{n} )}{{Q}_{{DV}_{1}}} ] - α \cdot {Q}_{DVD} \cdot R [ \frac{R [ \frac{DCT ( {B}_{n - 1} )}{{Q}_{{DV}_{2}}} ]}{\frac{{Q}_{DVD}}{{Q}_{{DV}_{2}}}} ]}{\frac{{Q}_{DVD}}{{Q}_{{DV}_{1}}}} ] = R [ \frac{{Q}_{{DV}_{1}} \cdot R [ \frac{DCT ( {B}_{n} )}{{Q}_{{DV}_{1}}} ] - {Q}_{DVD} \cdot R [ \frac{{Q}_{{DV}_{2}} \cdot R [ \frac{DCT ( {B}_{n - 1} )}{{Q}_{{DV}_{2}}} ]}{{Q}_{DVD}} ]}{{Q}_{DVD}} ]$$

$$Hence$$

$$α \cdot {Q}_{{DV}_{1}} \cdot R [ \frac{R [ \frac{DCT ( {B}_{n - 1} )}{{Q}_{{DV}_{2}}} ]}{\frac{{Q}_{DVD}}{{Q}_{{DV}_{2}}}} ] = R [ \frac{{Q}_{{DV}_{2}} \cdot R [ \frac{DCT ( {B}_{n - 1} )}{{Q}_{{DV}_{2}}} ]}{{Q}_{DVD}} ]$$

Hence by setting

$$α = \frac{1}{{Q}_{{DV}_{1}}}$$

We have

x₃=QE_{DCT}

So the proposed method is equivalent to the baseline method for I-P prediction cases.

The new and efficient method is equivalent to the baseline method for P-P frame transcoding, where the reference frame is a P frame, as illustrated by the following:

For this purpose we use the following notations. Subscript 1,2 are frame numbers and S1 and S2 represent baseline method and the proposed method, respectively.

Since S1=S2 for I-P frames we have

x₃=QE_{DCT}→E_{1,S1}=E_{1,S2}→E′_{1,S1}=E′_{1,S2}

where E′ is the inverse quantized prediction error as shown in FIG. 3. If I′ and P′ are reconstructed frames for I and P frames respectively then we have,

P′_{1,S1}=E′_{1,S1}+I′_{1,S1}

P′_{1,S2}=E′_{1,S2}+I′_{1,S2}

So we have P′_{1,S1}=P′_{1,S2}. Let E₂ be the error between two successive P frames and Q_{DV}_{₃} be the quantization parameter for P₂, then we have:

$$\begin{matrix}{E}_{2 , S1} = R [ \frac{{Q}_{{DV}_{3}} {P}_{2} - {\hat{P}}_{1 , S1}}{{Q}_{DVD}} ] \\ {E}_{2 , S2} = R [ \frac{{P}_{2} - α \cdot {\hat{P}}_{1 , S1}}{\frac{{Q}_{DVD}}{{Q}_{{DV}_{3}}}} ] = R [ \frac{\frac{{Q}_{{DV}_{3}} {P}_{2} - {\hat{P}}_{1 , S1}}{{Q}_{{DV}_{3}}}}{\frac{{Q}_{DVD}}{{Q}_{{DV}_{3}}}} ]\end{matrix}$$

where α=1/Q_{DV}_{₃}. So we have:

E_{2,S1}=E_{2,S2}→E′_{2,S1}=E′_{2,S2}

P′_{2,S1}=E′_{2,S1}+P′_{1,S1}

P′_{2,S2}=E′_{2,S2}+P′_{1,S2}

Since P′_{2,S1}=P′_{2,S2} we show that the proposed method is valid for P-P cases. Combining all these results prove that the proposed method is equivalent to the baseline method.

### CONCLUSION

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

For example, while MPEG-2 standard is described for compressing DVD data, the invention is not necessarily limited to this.

What is claimed is:

1. A method comprising:
decoding encoded DV (digital video) data;
performing baseline inverse quantization on the decoded DV data;
determining differences between the inversely quantized DV data and a current reference frame;
performing baseline quantization on the differences to generate DVD (digital versatile disk) data; and
encoding the DVD data.

2. The method of claim 1, wherein the encoded DVD data is intraframe coded.

3. The method of claim 1, additionally comprising combining the baseline inverse quantization function and baseline quantization function into a single quantization function using a new quantizer.

4. The method of claim 1, additionally comprising:
performing inverse quantization on the DVD data;
combining the inversely quantized DVD data with the current reference frame to generate a new reference frame; and
repeating the method of claim 1 using the new reference frame.

5. A method comprising:
receiving encoded digital video (DV) data;
converting the DV data to digital versatile disc (DVD) format by removing discrete cosine transformation (DCT) and inverse DCT (IDCT) functionality from baseline DV decoding, and removing DCT functionality from baseline DVD encoding, and:
performing baseline inverse quantization (IQ) functionality on the decoded DV data;
determining differences between the inversely quantized DV data and a current reference frame;
performing baseline quantization (Q) functionality on the differences to generate the DVD data; and
encoding the DVD data; and
transmitting the DVD data to a system encoder.

6. The method of claim 5, wherein the encoded DVD data is intraframe coded.

7. The method of claim 5, additionally comprising combining the baseline inverse quantization function and baseline quantization function into a new quantization (NQ) function using a new quantizer.

8. The method of claim 7, wherein the new quantizer in the NQ function comprises:
α=Q_{DVD}/Q_{DV}, where QDVD corresponds to a baseline DVD quantizer,
and QDV corresponds to a baseline DV quantizer.

9. A method comprising:
decoding encoded DV data;
determining differences between the decoded DV data and a factored reference frame data, the factored reference frame being a current reference frame multiplied by a new quantizer;
performing new quantization on the differences, the new quantization performed using the new quantizer to generate DVD data; and
encoding the DVD data using variable length coding.

10. The method of claim 9, additionally comprising:
performing new inverse quantization on the DVD data;
combining the inverse quantized DVD data with the current reference frame to generate a new reference frame; and
multiplying the new reference frame by the new quantizer.

11. The method of claim 10, repeating the method at claim 9 using the new reference frame in place of the reference frame.

12. An apparatus comprising:
a VLD (variable length decoder) to decode encoded DV data;
a math unit to determine differences between the decoded DV data and a factored reference frame data, the factored reference frame being a current reference frame multiplied by a new quantizer;
an NQ (new quantizer) unit to quantize the differences using a new quantizer, generating DVD data; and
a VLC (variable length coder) unit to encode the DVD data.

13. The apparatus of claim 12, additionally comprising:
an IQ (inverse quantizer) unit to inversely quantize the DVD data; and
a math unit to combine the inversely quantized DVD data and the current reference frame to generate a new reference frame.

14. The apparatus of claim 12, wherein the new quantizer in the NQ function comprises:
α=Q_{DVD}/Q_{DV}, where QDVD corresponds to a baseline DVD quantizer,
and QDV corresponds to a baseline DV quantizer.

15. A system comprising:
a memory to store a sequence of instructions;
a bus coupled to the memory to transmit the sequence of instructions to a processor; and
the processor coupled to the bus to receive the sequence of instructions and to:
receive encoded digital video (DV) data from an IEEE (Institute of Electronics and Electrical Engineers) 1394 interface; and
convert the DV data to digital versatile disk (DVD) data by:
decoding the encoded DV data;
determining differences between the decoded DV data and a factored reference frame data, the factored reference frame being a current reference frame multiplied by a new quantizer;
performing new quantization on the differences, the new quantization performed using the new quantizer to generate DVD data; and
encoding the DVD data.

16. The system of claim 15, the processor to additionally transmit the encoded DVD data to a system encoder to combine the encoded DVD data with audio data.

17. The system of claim 16, the processor to additionally:
perform new inverse quantization (NIQ) on the DVD data;
combine the NIQ DVD data with the current reference frame to generate a new reference frame;
repeat the conversion of the DV data to digital versatile disk (DVD) data as outlined in claim 15.

18. The system of claim 15, wherein the new quantization is performed using the new quantizer comprising:
α=Q_{DVD}/Q_{DV}, where QDVD corresponds to a baseline DVD quantizer, and QDV corresponds to a baseline DV quantizer.

19. A system comprising:
a memory to store a sequence of instructions;
a bus coupled to the memory to transmit the sequence of instructions to a processor; and
the processor to receive the sequence of instructions from the bus and to receive encoded digital video (DV) data from a USB (Universal Serial Bus) interface, and convert the DV data to digital versatile disk (DVD) data by:
decoding the encoded DV data;
determining differences between the decoded DV data and a factored reference frame data, the factored reference frame being a current reference frame multiplied by a new quantizer;
performing new quantization on the differences, the new quantization performed using the new quantizer to generate DVD data; and
encoding the DVD data.

20. The system of claim 19, the processor to additionally transmit the encoded DVD data to a system encoder to combine the encoded DVD data with audio data.

21. The system of claim 20, the processor to additionally:
perform new inverse quantization (NIQ) on the DVD data;
combine the NIQ DVD data with the current reference frame to generate a new reference frame;
repeat the conversion of the DV data to digital versatile disk (DVD) data as outlined in claim 19.

22. A machine-readable medium having stored thereon data representing sequences of instructions, the sequences of instructions which, when executed by a processor, cause the processor to perform the following:
receive encoded digital video (DV) data;
convert the DV data to digital versatile disc (DVD) format by removing discrete cosine transformation (DCT) and inverse DCT (IDCT) functionality from baseline DV decoding, and remove DCT functionality from baseline DVD encoding, and:
perform baseline inverse quantization (IQ) functionality on the decoded DV data;
determine differences between the inversely quantized DV data and a current reference frame;
perform baseline quantization (Q) functionality on the differences to generate the DVD data; and
encode the DVD data; and
transmit the DVD data to a system encoder.

23. The machine-readable medium of claim 22, wherein the encoded DVD data is intraframe coded.

24. The machine-readable medium of claim 22, additionally comprising combining the baseline inverse quantization function and baseline quantization function into a new quantization (NQ) function using a new quantizer.

25. The machine-readable medium of claim 24, wherein the new quantizer in the NQ function comprises:
α=Q_{DVD}/Q_{DV}, where QDVD corresponds to a baseline DVD quantizer,
and QDV corresponds to a baseline DV quantizer.

26. A machine-readable medium having stored thereon data representing sequences of instructions, the sequences of instructions which, when executed by a processor, cause the processor to perform the following:
decode encoded DV data;
determine differences between the decoded DV data and a factored reference frame data, the factored reference frame being a current reference frame multiplied by a new quantizer;
perform new quantization on the differences, the new quantization performed using the new quantizer to generate DVD data; and
encode the DVD data using variable length coding.

27. The machine-readable medium of claim 26, the sequence of instructions to additionally cause the processor to:
perform new inverse quantization on the DVD data;
combine the inverse quantized DVD data with the current reference frame to generate a new reference frame; and
multiply the new reference frame by the new quantizer.

28. The machine-readable medium of claim 27, the sequence of instructions to additionally cause the processor to repeat the method at claim 26 using the new reference frame in place of the reference frame.

29. An apparatus comprising:
at least one processor; and
a machine-readable medium having instructions encoded thereon, which when executed by the processor, are capable of directing the processor to:
receive encoded digital video (DV) data;
convert the DV data to digital versatile disc (DVD) format by removing discrete cosine transformation (DCT) and inverse DCT (IDCT) functionality from baseline DV decoding, and remove DCT functionality from baseline DVD encoding, and:
perform baseline inverse quantization (IQ) functionality on the decoded DV data;
determine differences between the inversely quantized DV data and a current reference frame;
perform baseline quantization (Q) functionality on the differences to generate the DVD data; and
encode the DVD data; and
transmit the DVD data to a system encoder.

30. The apparatus of claim 26, wherein the encoded DVD data is intraframe coded.

31. The apparatus of claim 26, additionally comprising combining the baseline inverse quantization function and baseline quantization function into a new quantization (NQ) function using a new quantizer.

32. An apparatus comprising:
means for decoding encoded DV data;
means for determining differences between the decoded DV data and a factored reference frame data, the factored reference frame being a current reference frame multiplied by a new quantizer;
means for quantizing the differences using a new quantizer, generating DVD data; and
means for encoding the DVD data.

33. The apparatus of claim 12, additionally comprising:
means for inversely quantizing the DVD data; and
means for combining the inversely quantized DVD data and the current reference frame to generate a new reference frame.

34. The apparatus of claim 12, wherein the new quantizer in the NQ function comprises:
α=Q_{DVD}/Q_{DV}, where QDVD corresponds to a baseline DVD quantizer,
and QDV corresponds to a baseline DV quantizer.
